(19) United States
(12) Patent Application Publication
(10) Pub. No.: US 2018/0086160 A1
(43) Pub. Date: Mar. 29, 2018

(54) TIRE WITH MODIFIED VALVE STEM

(71) Applicant: The Goodyear Tire & Rubber Company, Akron, OH (US)

(72) Inventors: Cheng-Hsiung LIN, Hudson, OH (US); Arun Kumar BYATARAYANAPURA GOPALA, Copley, OH (US)

(21) Appl. No.: 15/707,052

(22) Filed: Sep. 18, 2017

Related U.S. Application Data
(60) Provisional application No. 62/398,981, filed on Sep. 23, 2016.

(51) Int. Cl. B60C 23/12; B60C 29/00; F16K 15/20

(52) U.S. Cl. CPC B60C 23/12; F16K 15/20; B60C 29/005

(57) ABSTRACT

The present invention relates generally to an air maintenance system for use with a tire and, more specifically, to an air maintenance pumping assembly

### FIELD OF THE INVENTION

The present invention relates generally to an air maintenance system for use with a tire and, more specifically, to an air maintenance pumping assembly.

### BACKGROUND OF THE INVENTION

Normal air diffusion reduces tire pressure over time. The natural state of tires is under inflated. Accordingly, drivers must repeatedly act to maintain tire pressures or they will see reduced fuel economy, tire life and reduced vehicle braking and handling performance Tire Pressure Monitoring Systems have been proposed to warn drivers when tire pressure is significantly low. Such systems, however, remain dependent upon the driver taking remedial action when warned to re-inflate a tire to recommended pressure. It is a desirable, therefore, to incorporate an air maintenance feature within a tire that will maintain air pressure within the tire in order to compensate for any reduction in tire pressure over time without the need for driver intervention.

### Definitions

“Aspect ratio” of the tire means the ratio of its section height (SH) to its section width (SW) multiplied by 100 percent for expression as a percentage.

“Asymmetric tread” means a tread that has a tread pattern not symmetrical about the center plane or equatorial plane EP of the tire.

“Axial” and “axially” means lines or directions that are parallel to the axis of rotation of the tire.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Groove” means an elongated void area in a tire dimensioned and configured in section for receipt of an air tube therein.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint as measured under normal load and tire inflation, the lines being parallel to the equatorial centerplane.

“Net contact area” means the total area of ground contacting tread elements between the lateral edges around the entire circumference of the tread divided by the gross area of the entire tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Tread element” or “traction element” means a rib or a block element defined by having a shape adjacent grooves.

“Tread Arc Width” means the arc length of the tread as measured between the lateral edges of the tread.

### BRIEF DESCRIPTION OF THE DRAWINGS

The invention will be described by way of example and with reference to the accompanying drawings in which:

FIG. 1 illustrates a schematic sectional view of part of a tire in accordance with the present invention.

FIG. 2 illustrates a close-up perspective view of a pump of the present invention.

FIG. 3 illustrates the pump system of FIG. 1 shown with the components in cross-section.

FIG. 4 illustrates a double channel connector of the present invention.

FIG. 5 illustrates a cross-sectional view of the double channel connector of the present invention.

FIG. 6 illustrates an exploded view of the double channel connector of the present invention.

FIG. 7 illustrates a schematic of a first embodiment of a pump system of the present invention utilizing two double chamber pumps operated by an external mass.

FIG. 8 illustrates a schematic of a second embodiment of a pump system of the present invention utilizing two single chamber pumps operated by an external mass.

FIG. 9A illustrates a perspective view of a third embodiment of a pump system of the present invention, while FIG. 9B illustrates the bottom view of FIG. 9A.

### DETAILED DESCRIPTION OF AN EXAMPLE OF THE PRESENT INVENTION

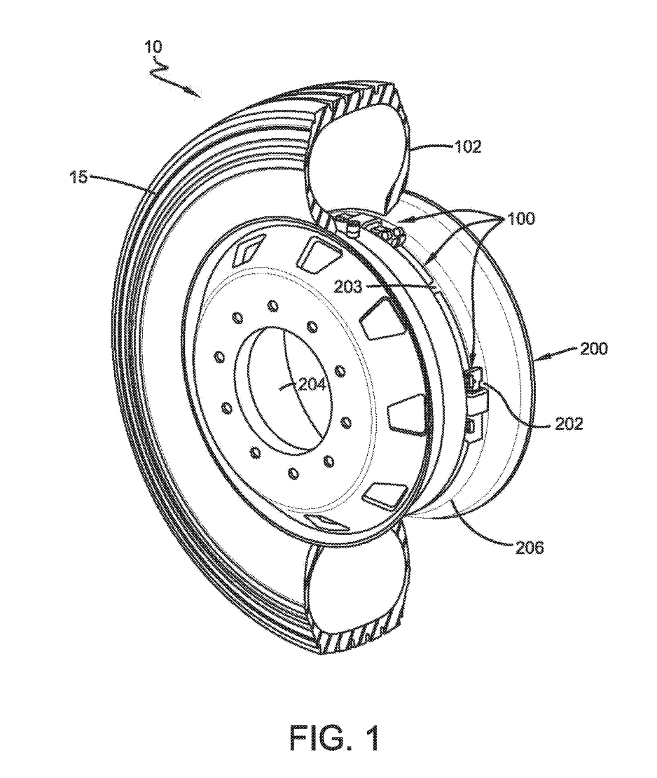

The present invention is directed to an air maintenance system 10, shown in FIG. 1. The air maintenance system includes one or more pump assemblies 100 that may be used to pump air to a tire. The tire may comprise a conventional tire that mounts in conventional fashion to rim 200 formed of a pair of rim mounting surfaces 204 that supports the tire assembly. The tire is of conventional construction, having a pair of sidewalls extending from opposite bead areas to a crown or tire bead region. The tire 15 and rim 200 encloses a tire cavity 102.

The pump assembly 100 of the present invention is mounted to an inner surface 202 of the tire rim 200 that is located inside the tire cavity 102. The rim may preferably comprise a U shaped groove 203 for mounting the pump assembly 100. The pump assembly may alternatively be located on the outer rim surface 204, opposite the inner surface 202.

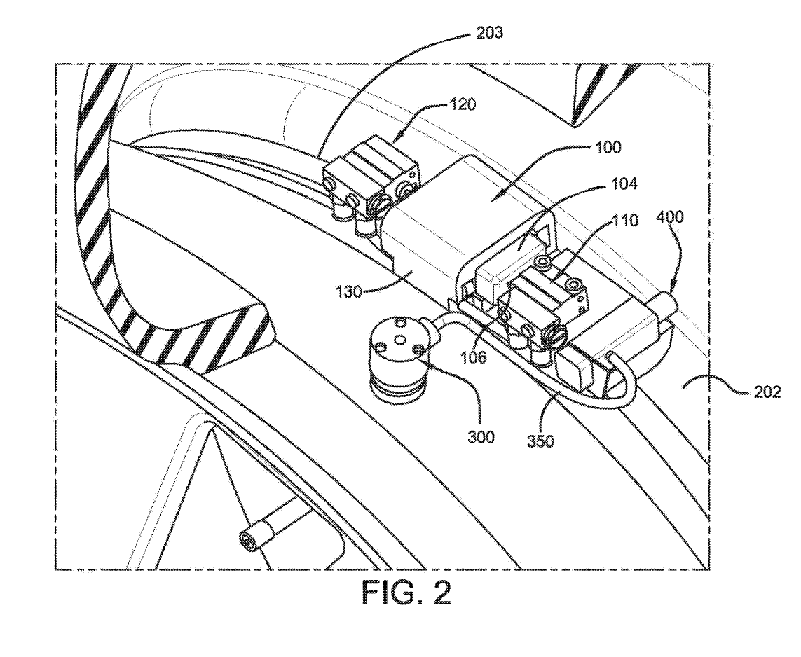

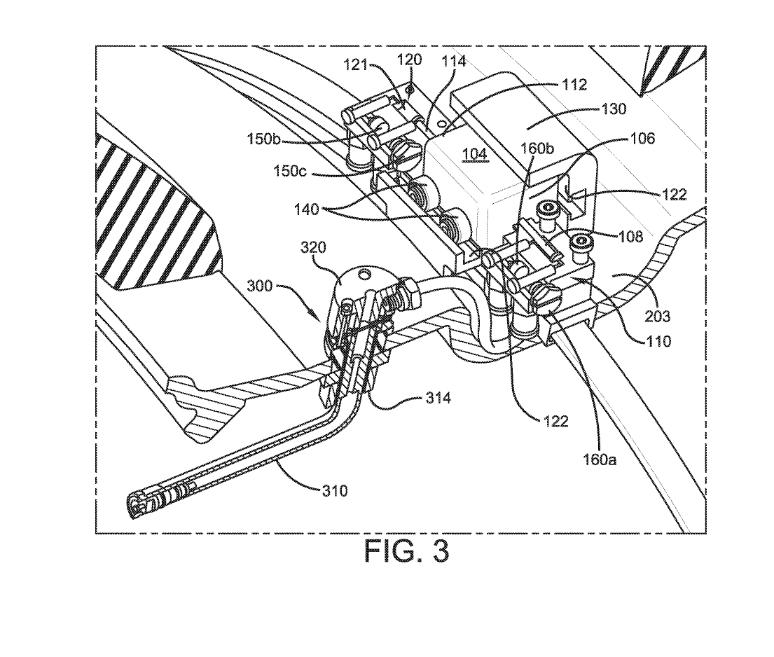

The pump assembly 100 as shown in FIGS. 2-3, includes an external sliding mass 104. The external sliding mass 104 has a first end 106 connected to a first piston 108 of a first pump 110. The sliding mass 104 has a second end 112 connected to a second piston 114 of a second pump 120. The sliding mass 104 preferably slides in a linear direction, and may be mounted in a groove or track 122 of a mounting sleeve 130. More preferably, the sliding mass 104 has wheels or bearings 140 to reduce the friction of the sliding mass 103 within the track 122. When the sliding mass slides, the pistons 108, 114 compress the air in the chambers.

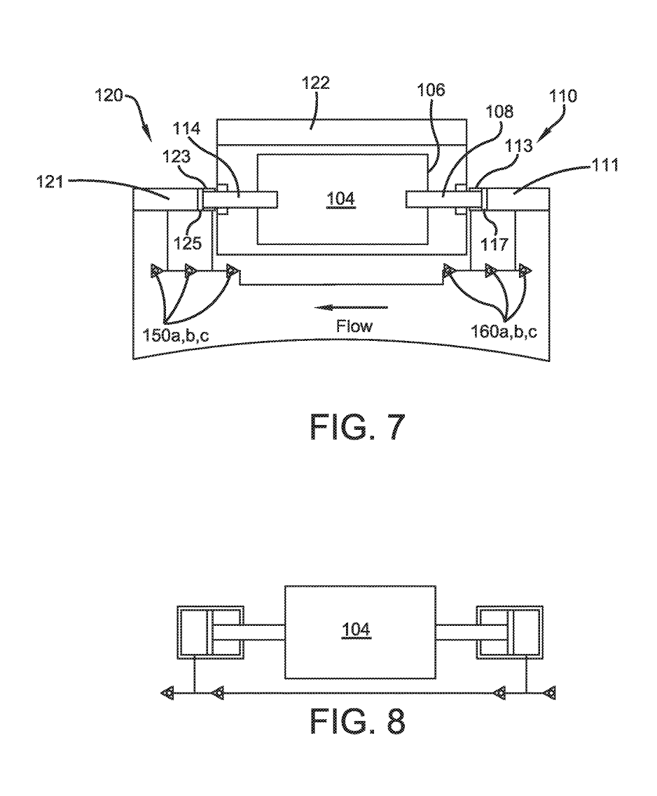

Preferably, each pump 110,120 is a double chamber pump having two chambers. Thus, first pump 110 has first pump chamber 111 and second pump chamber 113. The second pump 120 has first pump chamber 121 and second pump chamber 123. Each piston 108,114 forms a seal to allow for the two internal chambers of each pump. FIGS. 3 and 7 illustrate that each pump 110,120 is preferably in fluid communication with one or more check valves 150,160. As shown in FIG. 7, the direction of flow is shown from right to left. Preferably, a check valve 160c is located upstream of the first chamber 111 of the first pump 110. Flow from the first pump chamber is directed into the second pump chamber 113 (i.e., the chambers are connected in series). Preferably, an optional check valve 160b is located between the first chamber 111 and the second chamber 113. Preferably, an optional check valve 160a is located downstream of the second chamber 113. How from the second chamber 113 of the first pump 110 is then directed to the second chamber 123 of the second pump 120. Preferably, an optional check valve 150c is located upstream of the first chamber. The flow is then directed from the second chamber 123 of the second pump into the first chamber 121 of the second pump. An optional check valve 150b is preferably located in the flow path between the two chambers. Flow from the first chamber 121 is then directed through an optional check valve 150a. If only one pump assembly 100 is used, then the output flow from the pump assembly 100 is directed into the tire cavity.

Preferably, there are at least two pump assemblies 100 connected in series.

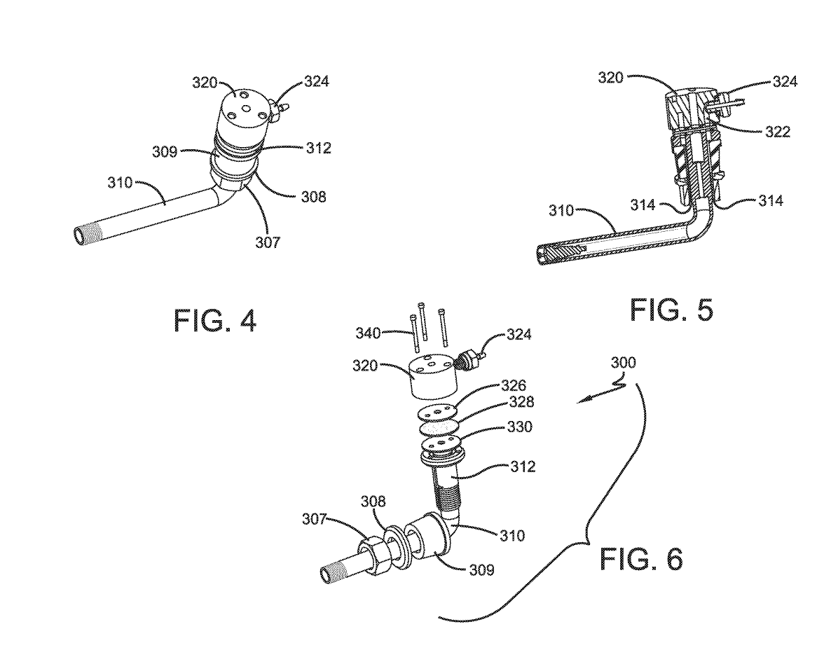

Airflow is introduced into the pump assembly 100 via a modified valve stem assembly 300. The pump assembly 100 may optionally include an inlet control valve 400 that opens flow to the pump system when the tire cavity pressure is below a threshold set pressure. The modified valve stem assembly 300 in shown in FIGS. 4-6. The modified valve stem assembly 300 provides air from the outside to be pumped in the pump assemblies 100. The modified valve stem assembly allows the standard valve stem function to allow air to be filled in the tire the conventional way and allow for the tire pressure to be checked in the conventional way. The valve stem body 312 has been modified to include one or more passageways 314 that communicates outside air through the body 312 and into flow channels 322 of a double channel connector 320. As the outside air travels through the passageways 314, it is filtered by filter 328. A first and second gasket 326,330 prevents leakage. The double channel connector 320 has an adaptor 324 for connecting to a tube 350. The tube 350 is preferably connected to an inlet control valve 400. The inlet control valve senses the tire cavity pressure, and if the cavity pressure is below the threshold level, the inlet control valve allows the air to pass through to the pump assemblies 100. If the tire pressure is above the threshold, the inlet control valves remains closed.

Preferably, there are at least two pump assemblies 100 connected together, i.e., in series. Due to an amplification effect, the compression of the pump assembly may be defined as:

R=(r)²ⁿ

where

R: system compression ratio

r: single chamber compression ratio

n: number of pump in the system

Thus, a high compression ratio for each pump chamber is not necessary to achieve a high compression ratio (e.g., low force and/or deformation may produce high compression).

The pump assembly of the present invention is bi-directional. Hence, the rotation direction or installation direction will not have significant effect on pumping performance

The pump driving mechanism of the present invention is based on gravitation change of the external mass during tire rotation. As the wheel is rotated, the pistons move forward and backward per revolution that provided high pumping frequency. Higher vehicle speed provides higher pumping frequency. The pumping action only depends on the external mass, and will not be affected by tire load or any other external conditions.

FIG. 8 is an alternate embodiment of the present invention. Instead of each pump having a dual chamber, the invention may also provide for single chamber pumps which are driven by an external mass. Two single chamber pumps are connected together in series, and are driven by a single external mass that drives the pistons to compress the air in the respective chambers. Check valves may be used as shown to prevent backflow.

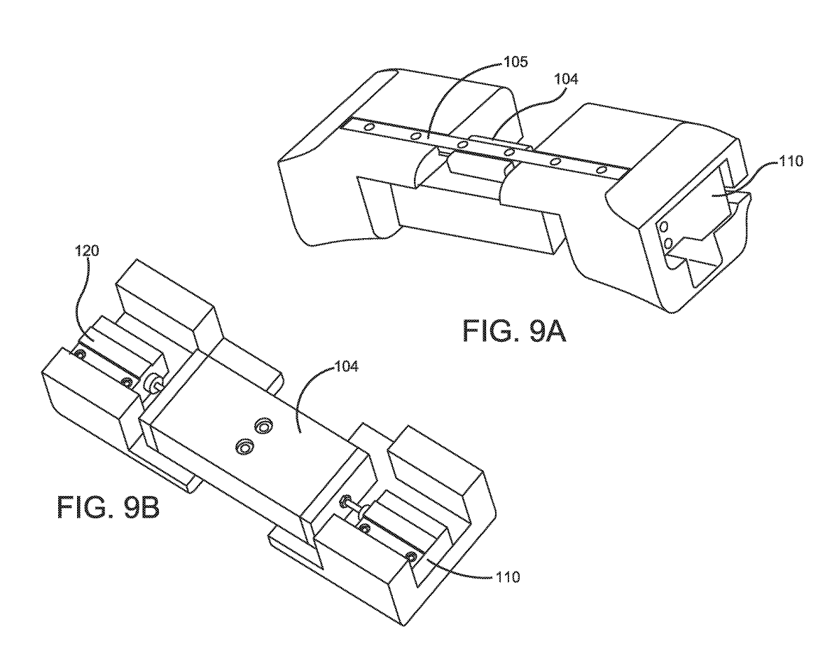

FIGS. 9a,9b illustrate an alternate embodiment of the present invention in which a sliding weight 104 is mounted upon a rail 105, so that the motion of the sliding weight is constrained in a linear direction.

While certain representative examples and details have been shown for the purpose of illustrating the present invention, it will be apparent to those skilled in this art that various changes and modifications may be made therein without departing from the spirit or scope of the present invention.

What is claimed:

1. An air maintenance tire assembly comprising:
a tire having a tire cavity bounded by first and second sidewalls extending to a tire tread region;
air pumping means for generating pressurized air for maintaining air pressure within the tire cavity at a preset pressure level;
the tire having a valve stem projecting outward from the tire cavity and having an internal air passageway in communication with the tire cavity and operative to direct pressurized air into the cavity; and
said valve stem further comprising a second air passageway having an inlet end in fluid communication with the outside air and an outlet end in fluid communication with the air pumping means.

2. A pneumatic tire and rim assembly comprising:
a pump assembly mounted within the tire cavity, said pump assembly having an outlet in fluid communication with the tire cavity, said pump assembly further comprising an inlet connected to a modified valve stem assembly, said modified valve stem assembly having a valve body having a first and second internal flow passageway, said first internal flow passageway being in fluid communication with the tire cavity and the valve core, and said second internal flow passageway being in fluid communication with the air outside of the tire and the inlet of the pump assembly.

3. The pneumatic tire and rim assembly of claim 1 further including a connector mounted upon a first end of the valve body, wherein the first end is positioned within the tire cavity, wherein the connector has an internal channel in fluid communication with the second internal flow passageway.

4. The pneumatic tire and rim assembly of claim 2 wherein the connector further includes a filter positioned within the internal channel for filtering the outside air.

5. The pneumatic tire and rim assembly of claim 1 wherein the pump assembly further including a first and second pump each mounted to a wheel rim of the rim assembly, said first and second pump each having a piston mounted in a chamber, an external mass being connected to each piston, wherein said external mass operates the pump assemblies during rotation of the tire.

6. The pneumatic tire and rim assembly of claim 1 wherein the first and second pump assembly are connected in series.

7. The pneumatic tire and rim assembly of claim 1 wherein a check valve is provided between the first and second pump assembly.
